(19) United States
(12) Patent Application Publication
(10) Pub. No.: US 2026/0018700 A1
(43) Pub. Date: Jan. 15, 2026

(54) COOLER, ARRANGEMENT STRUCTURE OF SUPPLY-DISCHARGE PORTION, AND ELECTRICITY STORAGE APPARATUS

(71) Applicant: TOYOTA JIDOSHA KABUSHIKI KAISHA, Aichi-ken (JP)

(72) Inventor: Osamu YAMASHITA, Toyota-shi (JP)

(21) Appl. No.: 19/260,609

(22) Filed: Jul. 7, 2025

(30) Foreign Application Priority Data
Jul. 10, 2024 (JP) 2024-110777

(51) Int. Cl. H01M 10/656; H01M 10/613; H01M 10/625

(52) U.S. Cl. CPC H01M 10/656; H01M 10/613; H01M 10/625; H01M 2220/20

(57) ABSTRACT

A cooler mounted on an electricity storage apparatus includes: a cooler main body in which a circulation passage of a refrigerant is provided; and a supply-discharge portion that communicates with the circulation passage of the cooler main body and is to be inserted into the cooler main body to supply the refrigerant to the circulation passage of the cooler main body or discharge the refrigerant from the circulation passage of the cooler main body. The supply-discharge portion includes a contacting portion that arranges the supply-discharge portion in a preset position in the cooler main body by being in contact with a portion to be contacted of the electricity storage apparatus, in a state in which the cooler is mounted on the electricity storage apparatus.

### CROSS-REFERENCE TO RELATED APPLICATION

This application claims priority to Japanese Patent Application No. 2024-110777 filed on Jul. 10, 2024. The disclosure of the above-identified application, including the specification, drawings, and claims, is incorporated by reference herein in its entirety.

### BACKGROUND

### 1. Technical Field

The present disclosure relates to a cooler, an arrangement structure of a supply-discharge portion, and an electricity storage apparatus.

### 2. Description of Related Art

A cooler is mounted on an electricity storage apparatus in order to cool a battery module. For example, a cooler in CN 116848705 A has a configuration in which a supply-discharge portion having a fixed cap is brazed to a cooler main body formed by an extruded material of aluminum.

### SUMMARY

The cooler in CN 116848705 A has a configuration in which the supply-discharge portion having a fixed cap is brazed to the cooler main body, and hence manufacturing is complicated.

The present disclosure realizes a cooler, an arrangement structure of a supply-discharge portion, and an electricity storage apparatus that are easy to manufacture.

A cooler to be mounted on an electricity storage apparatus of a first aspect of the present disclosure includes a cooler main body and a supply-discharge portion. In the cooler main body, a circulation passage of a refrigerant is provided. The supply-discharge portion communicates with the circulation passage of the cooler main body and is configured to be inserted into the cooler main body to supply the refrigerant to the circulation passage of the cooler main body or discharge the refrigerant from the circulation passage of the cooler main body. The supply-discharge portion includes a contacting portion configured to arrange the supply-discharge portion in a preset position in the cooler main body by being in contact with a portion to be contacted of the electricity storage apparatus, in a state in which the cooler is mounted on the electricity storage apparatus.

In the cooler according to the first aspect of the present disclosure, the portion to be contacted of the electricity storage apparatus may be a case of the electricity storage apparatus.

In the cooler according to the first aspect of the present disclosure, the supply-discharge portion may include an insertion portion configured to be inserted into the cooler main body, and a first packing member configured to be fixed to an inner peripheral surface of the insertion portion.

In the cooler according to the first aspect of the present disclosure, the insertion portion and the first packing member may be integrally formed by resin.

In the cooler according to the first aspect of the present disclosure, the cooler main body may be an extruded material of aluminum. The insertion portion may be configured to be inserted into an end portion of the cooler main body and include an insertion portion main body having a cap shape.

In the cooler according to the first aspect of the present disclosure, the supply-discharge portion may include an engaging portion configured to be engaged with a portion to be engaged provided in the cooler main body.

In the cooler according to the first aspect of the present disclosure, the cooler main body may have a second packing member configured to come into contact with the supply-discharge portion.

An arrangement structure of a supply-discharge portion that is arranged on a cooler main body in a cooler to be mounted on an electricity storage apparatus to supply a refrigerant to the cooler main body or discharge the refrigerant from the cooler main body of a second aspect of the present disclosure includes the supply-discharge portion being inserted into the cooler main body, and the supply-discharge portion being arranged in a preset position in the cooler main body by being in contact with a portion to be contacted of an electricity storage apparatus, in a state in which the cooler is mounted on the electricity storage apparatus.

The electricity storage apparatus of a third aspect of the present disclosure includes the cooler according to the first aspect.

In the electricity storage apparatus according to the third aspect of the present disclosure, the cooler may be configured to be arranged between battery modules.

In the electricity storage apparatus according to the third aspect of the present disclosure, an insertion portion may include an insertion portion main body and a first communication portion. The insertion portion main body may be configured to be inserted into the cooler main body. The first communication portion may be provided in the insertion portion main body and communicates with the circulation passage of the cooler main body. The first communication portion and a second communication portion may be configured to be joined by a fitting structure. The second communication portion may be a communication portion of a supply-discharge portion in a predetermined cooler. The battery module may be between the cooler and the predetermined cooler. The cooler and the predetermined cooler may be adjacent to each other.

With the present disclosure, it becomes possible to realize the cooler, the arrangement structure of the supply-discharge portion, and the electricity storage apparatus that are easy to manufacture.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view showing a relationship between battery modules, coolers, and a case of an electricity storage apparatus of Embodiment 1 in a simplified manner;

FIG. 2 is an exploded perspective view showing a cooler main body and a supply-discharge portion in a part of the cooler on the Y-axis − side of the cooler in the electricity storage apparatus of Embodiment 1;

FIG. 3 is a perspective view showing a part of the cooler main body on the Y-axis − side of the cooler main body of the cooler in the electricity storage apparatus of Embodiment 1;

FIG. 4 is a sectional view showing the supply-discharge portion of the cooler on the Y-axis − side of the cooler in the electricity storage apparatus of Embodiment 1;

FIG. 5 is a view of a connecting pipe in the electricity storage apparatus of Embodiment 1 seen from the Y-axis + side;

FIG. 6 is a view of the connecting pipe in the electricity storage apparatus of Embodiment 1 seen from the X-axis − side;

FIG. 7 is a partial sectional view showing an engagement structure between a cooler main body and a supply-discharge portion in a part of a cooler on the Y-axis − side of the cooler in an electricity storage apparatus of Embodiment 2;

FIG. 8 is a perspective view showing a part of the cooler main body on the Y-axis − side of the cooler main body in the electricity storage apparatus of Embodiment 2;

FIG. 9 is a perspective view showing the supply-discharge portion of the cooler on the Y-axis − side of the cooler in the electricity storage apparatus of Embodiment 2; and

FIG. 10 is a view showing a relationship between battery modules, coolers, and a case of an electricity storage apparatus of Embodiment 3 in a simplified manner.

### DETAILED DESCRIPTION OF EMBODIMENTS

Specific embodiments to which the present disclosure is applied are described in detail below with reference to the drawings. However, the present disclosure is not limited to the embodiments below. The wordings and the drawings below are simplified, as appropriate, in order to clarify the description. In the description below, description is made with use of a three-dimensional (XYZ) coordinate system in order to clarify the description.

### Embodiment 1

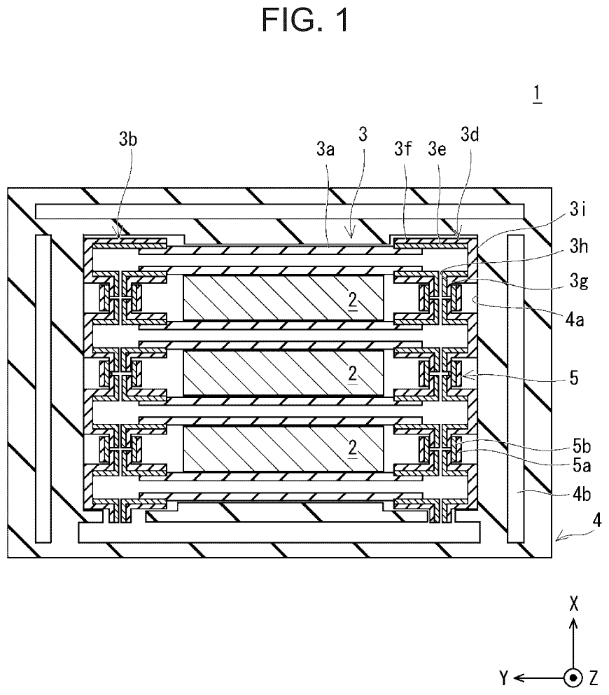

FIG. 1 is a view showing a relationship between battery modules, coolers, and a case of an electricity storage apparatus of the present embodiment in a simplified manner. An electricity storage apparatus 1 is suitable as an electricity storage apparatus mounted on a vehicle, for example. The electricity storage apparatus 1 includes battery modules 2, coolers 3, and a case 4.

The battery modules 2 are formed by electrically connecting battery cells stacked in the Y-axis direction to each other, for example. As shown in FIG. 1, the battery modules 2 are arranged to be spaced apart from each other in the X-axis direction, for example. The battery modules 2 are not limited to lithium-ion batteries and may be nickel hydride batteries, nickel cadmium batteries, solid-state batteries, or the like.

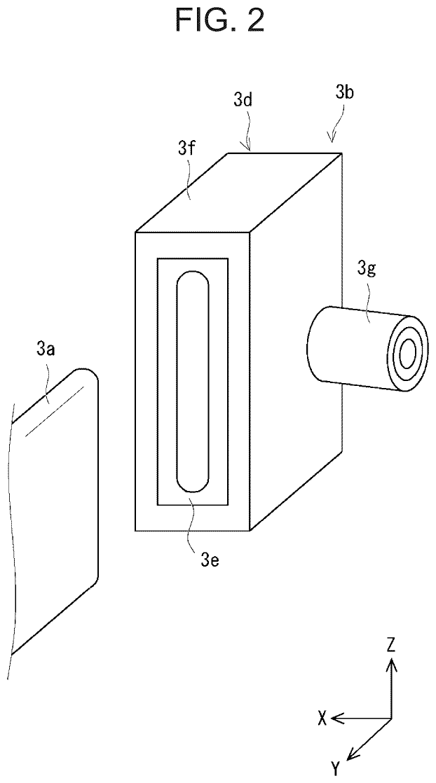

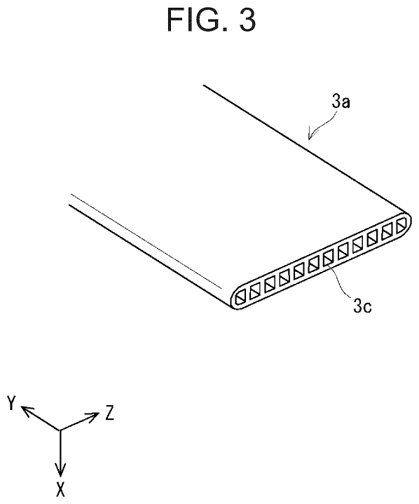

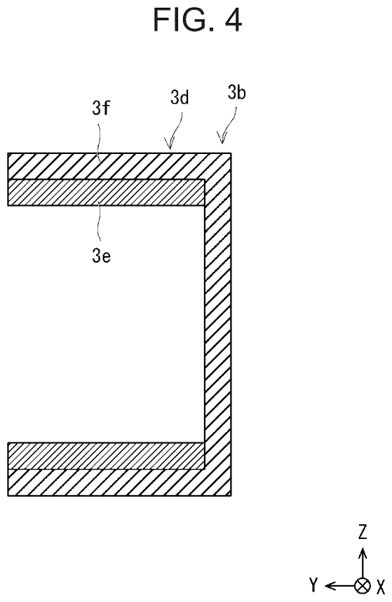

FIG. 2 is an exploded perspective view showing a cooler main body and a supply-discharge portion in a part of the cooler on the Y-axis − side of the cooler in the electricity storage apparatus of the present embodiment. FIG. 3 is a perspective view showing a part of the cooler main body on the Y-axis − side of the cooler main body of the cooler in the electricity storage apparatus of the present embodiment. FIG. 4 is a sectional view showing the supply-discharge portion of the cooler on the Y-axis − side of the cooler 10 in the electricity storage apparatus of the present embodiment.

As shown in FIG. 2, the cooler 3 includes a cooler main body 3a and a supply-discharge portion 3b. As shown in FIG. 3, the cooler main body 3a has a substantially rectangular shape when seen from the Y-axis direction and extends in the Y-axis direction, for example. The cooler main body 3a may be an extruded material of aluminum (including aluminum alloy).

In other words, an end portion of the cooler main body 3a on the Y-axis + side of the cooler main body 3a and an end portion of the cooler main body 3a on the Y-axis − side of the cooler main body 3a may be open as shown in FIG. 3. Circulation passages 3c through which a refrigerant circulates are formed on the inside of the cooler main body 3a. The circulation passages 3c extend in the Y-axis direction. A plurality of the circulation passages 3c are lined up in the Z-axis direction. Here, the refrigerant may be flowable gas or liquid.

As shown in FIG. 2 and FIG. 4, the supply-discharge portion 3b includes an insertion portion 3d and a packing 3e, for example. The insertion portion 3d includes an insertion portion main body 3f and a communication portion 3g. The insertion portion main body 3f has a cap shape that can be fitted onto the end portion of the cooler main body 3a in the Y-axis direction. The insertion portion main body 3f has an end portion on the Y-axis + side or an end portion on the Y-axis − side that are closed.

As shown in FIG. 1 and FIG. 2, an perforated portion 3h is formed in at least one of an end portion on the insertion portion main body 3f on the X-axis + side of the insertion portion main body 3f or an end portion of the insertion portion main body 3f on the X-axis − side of the insertion portion main body 3f. The communication portion 3g has a substantially cylindrical shape and extends in the X-axis direction. The communication portion 3g protrudes from the insertion portion main body 3f to the outer side of the insertion portion main body 3f so as to be continuous from the perforated portion 3h of the insertion portion main body 3f.

The insertion portion 3d as above can be formed by resin having a high rigidity with respect to the packing 3e such as fiber reinforced nylon obtained by mixing nylon 66 with glass wool, for example. However, the insertion portion 3d may be made of metal and the like, and the material is not limited.

As shown in FIG. 1 and FIG. 2, the packing 3e is arranged along an inner peripheral surface of the insertion portion main body 3f. As shown in FIG. 1 and FIG. 4, the packing 3e may be fixed to a part on the Z-axis + side, a part on the Z-axis − side, a part on the X-axis + side, and a part on the X-axis − side in the inner peripheral surface of the insertion portion main body 3f, for example. The packing 3e may be also fixed to an inner peripheral surface of the communication portion 3g.

The packing 3e can be formed by resin that has elasticity with respect to the insertion portion 3d such as elastomer, for example. Here, when the insertion portion 3d and the packing 3e are formed by resin, the insertion portion 3d and the packing 3e can be integrally formed by two-color molding, for example. As a result, the supply-discharge portion 3b can be easily formed.

As shown in FIG. 1, the supply-discharge portions 3b are inserted into an end portion of the cooler main body 3a on the Y-axis + side of the cooler main body 3a and an end portion of the cooler main body 3a on the Y-axis − side of the cooler main body 3a. In other words, the insertion portion main bodies 3f of the supply-discharge portions 3b close open end portions of the cooler main body 3a in a state in which the insertion portion main bodies 3f are inserted into the cooler main body 3a.

As shown in FIG. 1, the supply-discharge portion 3b inserted into the end portion of the cooler main body 3a on the Y-axis + side of the cooler main body 3a and the supply-discharge portion 3b inserted into the end portion of the cooler main body 3a on the Y-axis − side of the cooler main body 3a are plane-symmetrical about an XZ plane serving as the plane of symmetry.

At this time, as shown in FIG. 1, the perforated portion 3h of the insertion portion main body 3f in the supply-discharge portion 3b is arranged in a position that does not interfere with the cooler main body 3a. The packing 3e of the supply-discharge portion 3b is in contact with an outer peripheral surface of the cooler main body 3a.

As shown in FIG. 1, the coolers 3 as above are arranged between the battery modules 2 lined up in the X-axis direction, are arranged on the X-axis + side with respect to the battery module 2 arranged on the X-axis + side, and are arranged on the X-axis − side with respect to the battery module 2 arranged on the X-axis − side, for example.

At this time, as shown in FIG. 1, the communication portion 3g of the supply-discharge portion 3b inserted into the cooler main body 3a of the cooler 3 arranged on the X-axis + side protrudes to the X-axis − side from the insertion portion main body 3f, and the communication portions 3g of the supply-discharge portion 3b inserted into the cooler main body 3a of another cooler 3 protrude to the X-axis + side and the X-axis − side from the insertion portion main body 3f, for example.

As shown in FIG. 1, the communication portions 3g facing each other in the X-axis direction are connected to each other by a connecting pipe 5 on each of the Y-axis + side and the Y-axis − side of the coolers 3, for example. For example, the communication portion 3g that protrudes to the X-axis − side from the insertion portion main body 3f of the supply-discharge portion 3b on the Y-axis + side of the cooler 3 arranged on the X-axis − side is connected to a supplying portion that supplies a refrigerant, and the communication portion 3g that protrudes to the X-axis − side from the insertion portion main body 3f of the supply-discharge portion 3b on the Y-axis − side of the cooler 3 arranged on the X-axis − side is connected to a discharging portion that discharges the refrigerant.

As a result, the refrigerant supplied from the supplying portion is supplied to the cooler main bodies 3a of the coolers 3 on the Y-axis + side from the supply-discharge portions 3b thereof, moves through the circulation passages 3c of the cooler main bodies 3a to the Y-axis − side, and then is discharged to the discharging portion from the supply-discharge portions 3b of the coolers 3 on the Y-axis − side thereof, for example. At this time, the battery modules 2 adjacent to the coolers 3 are cooled.

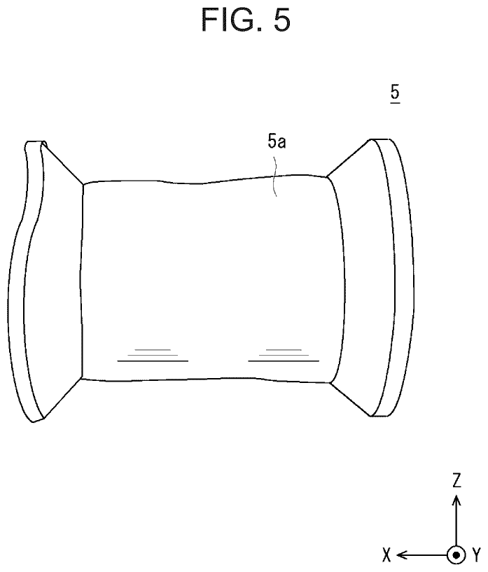

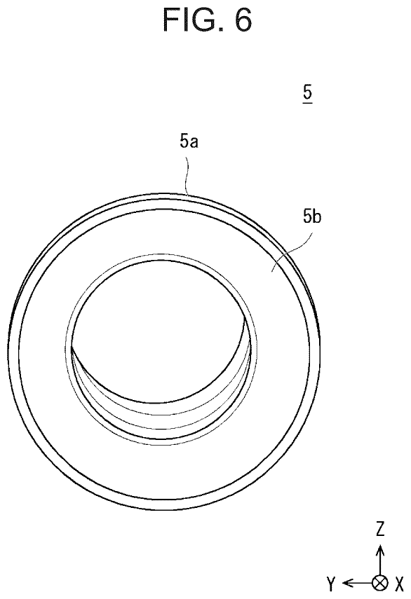

Here, FIG. 5 is a view of the connecting pipe in the electricity storage apparatus of the present embodiment seen from the Y-axis + side. FIG. 6 is a view of the connecting pipe in the electricity storage apparatus of the present embodiment seen from the X-axis − side. As shown in FIG. 5 and FIG. 6, the connecting pipe 5 includes a connecting pipe main body 5a and a packing 5b, for example.

As shown in FIG. 5 and FIG. 6, the connecting pipe main body 5a has a substantially cylindrical shape and extends in the X-axis direction. The connecting pipe main body 5a can be formed by resin having a high rigidity with respect to the packing 5b such as fiber reinforced nylon obtained by mixing nylon 66 with glass wool, for example.

As shown in FIG. 6, the packing 5b is fixed to an inner peripheral surface of the connecting pipe main body 5a. The packing 5b can be formed by resin having elasticity with respect to the connecting pipe main body 5a such as elastomer. However, the connecting pipe 5 may have a configuration that can connect the communication portions 3g of the coolers 3 facing each other in the X-axis direction to each other.

As shown in FIG. 1, the case 4 covers the battery modules 2 and the coolers 3. The case 4 includes an upper case and a lower case and houses the battery modules 2 and the coolers 3 in an inner space between the upper case and the lower case, for example.

At this time, end portions of the insertion portion main bodies 3f on the Y-axis + side of the insertion portion main bodies 3f of the supply-discharge portions 3b on the Y-axis + side in the coolers 3 may be substantially in contact with an inner peripheral surface of the case 4, and end portions of the insertion portion main bodies 3f on the Y-axis − side of the insertion portion main bodies 3f of the supply-discharge portions 3b on the Y-axis − side in the coolers 3 be substantially in contact with an inner peripheral surface of the case 4.

As a result, when the refrigerant is supplied to the coolers 3, the pressure on the inside of the coolers 3 rises, and the supply-discharge portions 3b are pressed to the outer sides of the cooler main bodies 3a with respect to the cooler main bodies 3a in the Y-axis direction, but the end portions of the supply-discharge portions 3b on the sides on the outer sides of the cooler main bodies 3a are substantially in contact with the inner peripheral surfaces of the case 4. Therefore, the movement of the supply-discharge portions 3b to the sides on the outer sides of the cooler main bodies 3a is restricted, and an arrangement structure in which the supply-discharge portions 3b are arranged in preset positions in the cooler main bodies 3a can be realized.

In other words, the end portions of the supply-discharge portions 3b on the sides on the outer sides of the cooler main bodies 3a can function as contacting portions 3i that are brought into contact with the inner peripheral surfaces of the case 4 in order to arrange the supply-discharge portions 3b in the preset positions in the cooler main bodies 3a, and the inner peripheral surfaces of the case 4 can function as portions to be contacted 4a with which the contacting portions 3i come into contact.

Therefore, there is no need to arrange the supply-discharge portions 3b with respect to the cooler main bodies 3a by performing brazing and the like, and the coolers 3 and therefore the electricity storage apparatus 1 can be easily manufactured. As shown in FIG. 1, the case 4 may include energy absorption (EA) portions 4b.

As above, with the coolers 3, the arrangement structure of the supply-discharge portions 3b, and the electricity storage apparatus 1, the supply-discharge portions 3b can be arranged in predetermined positions in the cooler main bodies 3a by a simple configuration in which the supply-discharge portions 3b are inserted into the cooler main bodies 3a and brought into contact with the case 4. Therefore, there is no need to arrange the supply-discharge portions 3b with respect to the cooler main bodies 3a by performing brazing and the like, and the coolers 3 and therefore the electricity storage apparatus 1 can be easily manufactured.

In particular, in the case of a configuration in which each of the insertion portion main bodies 3f of the supply-discharge portions 3b is formed in a cap shape and the insertion portion main bodies 3f are inserted into the cooler main bodies 3a so as to close the open end portions of the cooler main bodies 3a by the insertion portion main bodies 3f, a force to the side on the outer side of the cooler main bodies 3a that acts on the supply-discharge portions 3b by the refrigerant can be received by the case 4, and the supply-discharge portions 3b can be arranged in the preset positions in the cooler main bodies 3a in an extremely reasonable manner.

In the case in which the supply-discharge portions 3b are brought into contact with the case 4 and the supply-discharge portions 3b are arranged in preset positions in the cooler main bodies 3a, there is no need to separately process the case 4 and the electricity storage apparatus 1 can be easily manufactured.

When the insertion portion 3d and the packing 3e of the supply-discharge portion 3b are formed by resin, the insertion portion 3d and the packing 3e can be integrally formed by two-color molding, for example. As a result, the supply-discharge portion 3b can be easily formed.

### Embodiment 2

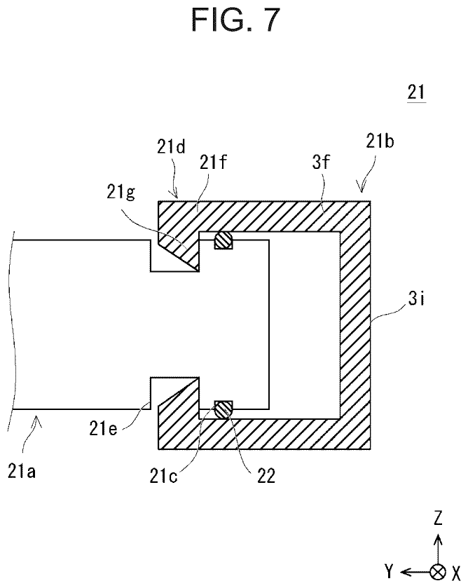

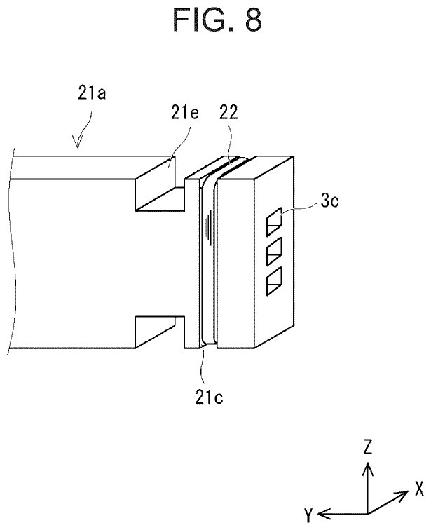

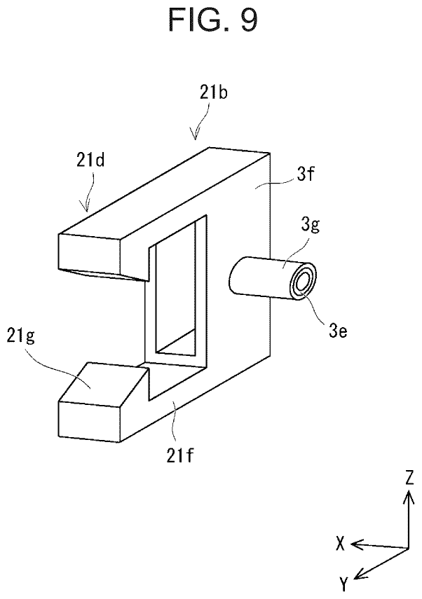

FIG. 7 is a partial sectional view showing an engagement structure between a cooler main body and a supply-discharge portion in a part of a cooler on the Y-axis − side of the cooler in an electricity storage apparatus of the present embodiment. FIG. 8 is a perspective view showing a part of the cooler main body on the Y-axis − side of the cooler main body in the electricity storage apparatus of the present embodiment. FIG. 9 is a perspective view showing the supply-discharge portion of the cooler on the Y-axis − side of the cooler in the electricity storage apparatus of the present embodiment.

As shown in FIG. 7, in the electricity storage apparatus of the present embodiment, a cooler 21 has a configuration substantially equivalent to that of the cooler 3 in Embodiment 1, but a cooler main body 21a and a supply-discharge portion 21b are engaged with each other by the engagement structure. In the description below, members equivalent to those of the electricity storage apparatus 1 of Embodiment 1 are described with use of equivalent reference characters.

In detail, as shown in FIG. 8, the cooler main body 21a has a substantially equivalent configuration as the cooler main body 3a in Embodiment 1. However, a groove portion 21c is formed in a position in the cooler main body 21a that overlaps with the supply-discharge portion 21b when the supply-discharge portion 21b is inserted into the cooler main body 21a, and the packing 22 is fitted into the groove portion 21c.

As shown in FIG. 8, the groove portion 21c is formed along an outer peripheral surface of the cooler main body 21a and is arranged in each of a part of the cooler main body 21a on the Y-axis + side of the cooler main body 21a and a part of the cooler main body 21a on the Y-axis − side of the cooler main body 21a, for example. The packing 22 may be a ring packing and protrudes from the outer peripheral surface of the cooler main body 21a in a state of being fitted into the groove portion 21c.

As shown in FIG. 7 and FIG. 8, the cooler main body 21a includes portions to be engaged 21e with which engaging portions 21d of the supply-discharge portion 21b are engaged, for example. The portions to be engaged 21e are arranged in the cooler main body 21a on the side on the inner side of the cooler main body 21a with respect to the groove portion 21c in the Y-axis direction, for example.

As shown in FIG. 8, the portions to be engaged 21e are arranged in an end portion of the cooler main body 21a on the Z-axis + side of the cooler main body 21a and an end portion of the cooler main body 21a on the Z-axis − side of the cooler main body 21a so as to face each other in the Z-axis direction, for example. The portions to be engaged 21e are groove portions having substantially rectangular shapes when seen from the X-axis direction and extend in the X-axis direction, for example. At this time, the groove portion 21c and the portions to be engaged 21e may be arranged so as not to overlap with the circulation passages 3c when seen from the Y-axis direction. As a result, the cooler main body 21a can be easily formed by extrusion-molding.

As shown in FIG. 9, the supply-discharge portion 21b has a configuration substantially equivalent to that of the supply-discharge portion 3b in Embodiment 1 but includes the engaging portions 21d. Here, in the present embodiment, a part in the packing 3e that is fixed to an inner peripheral surface of the insertion portion main body 3f can be omitted.

As shown in FIG. 7 and FIG. 9, each of the engaging portions 21d includes a protruding portion 21f and a claw portion 21g, for example. The protruding portions 21f protrude from an end portion of the insertion portion main body 3f on the Z-axis + side of the insertion portion main body 3f and an end portion of the insertion portion main body 3f on the Z-axis − side of the insertion portion main body 3f to the side opposite from the side of the insertion portion main body 3f in the Y-axis direction. The protruding portions 21f each have a substantial rectangular shape when seen from the Y-axis direction, for example.

As shown in FIG. 9, each of the claw portion 21g protrudes from a distal end portion of the corresponding protruding portion 21f to the side of the other protruding portion 21f. Each of the claw portions 21g has a substantially triangular shape that is inclined more toward the side of the other claw portion 21g as the side of the insertion portion main body 3f is approached when seen from the X-axis direction, for example.

As shown in FIG. 7, the supply-discharge portions 21b as above are inserted into an end portion of the cooler main body 21a on the Y-axis + side of the cooler main body 21a and an end portion of the cooler main body 21a on the Y-axis − side of the cooler main body 21a. At this time, the packing 22 comes into contact with the inner peripheral surface of the insertion portion main body 3f in the supply-discharge portion 21b.

Then, the claw portions 21g of the engaging portions 21d of the supply-discharge portion 21b are engaged with the portions to be engaged 21e of the cooler main body 21a. As a result, this can prevent the supply-discharge portion 21b from coming off from the cooler main body 21a.

At this time, each of the claw portions 21g of the engaging portions 21d of the supply-discharge portion 21b has a substantially triangular shape that is inclined more toward the side of the other claw portion 21g as the side of the insertion portion main body 3f is approached when seen from the X-axis direction, for example. Therefore, the claw portions 21g can satisfactorily pass over parts in the cooler main body 21a that are on the side on the outer side with respect to the portions to be engaged 21e. Therefore, the claw portions 21g of the engaging portions 21d of the supply-discharge portion 21b can be easily caused to engage with the portions to be engaged 21e of the cooler main body 21a.

### Embodiment 3

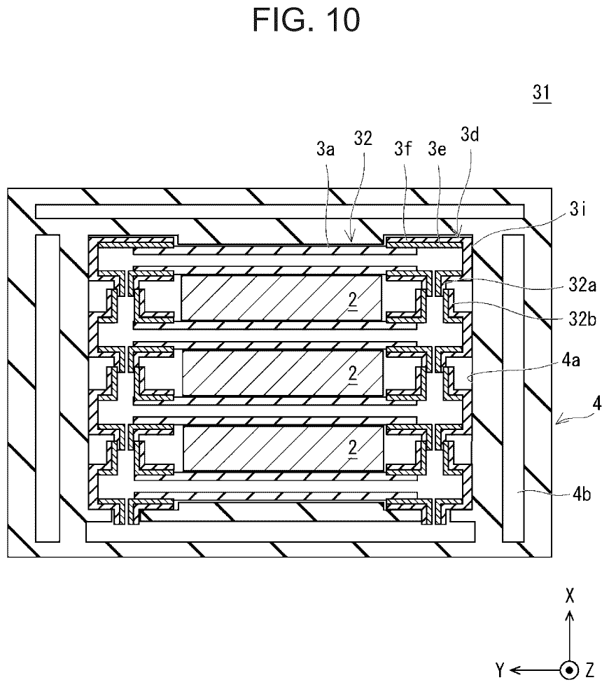

FIG. 10 is a view showing a relationship between battery modules, coolers, and a case of an electricity storage apparatus of the present embodiment in a simplified manner. As shown in FIG. 10, the electricity storage apparatus 1 of the present embodiment 3 has a configuration substantially equivalent to that of the electricity storage apparatus 1 of Embodiment 1, but communication portions 32a, 32b facing each other in the X-axis direction are joined to each other by a fitting structure on each of the Y-axis + side of coolers 32 and the Y-axis − side of the coolers 32.

For example, the outer diameter of one communication portion 32a may be smaller than the inner diameter of the other communication portion 32b and one communication portion 32a may be joined to the other communication portion 32b by being fitted into the inside of the other communication portion 32b. As a result, the coolers 32 adjacent to each other in the X-axis direction can be easily connected to each other without the use of the connecting pipe 5.

In the embodiments described above, the supply-discharge portion is arranged in a preset position in the cooler main body by bringing the supply-discharge portion into substantial contact with the case 4, but a portion to be contacted to be in substantial contact with the contacting portion of the supply-discharge portion may be separately provided in the case 4.

The contacting portion of the supply-discharge portion is not limited to an end surface of the insertion portion main body and may have a configuration that can come into contact with the portion to be contacted of the case 4. The portion to be contacted is not limited to the case 4 and may be one of the members of the electricity storage apparatus.

In the embodiments described above, the insertion portion main body of the supply-discharge portion has a cap shape. However, for example, when the end portion of the cooler main body on the Y-axis + side of the cooler main body and the end portion of the cooler main body on the Y-axis − side of the cooler main body are closed and a through-hole through which the refrigerant passes is formed in the cooler main body, the insertion portion main body of the supply-discharge portion may have an ring shape that can be inserted into the cooler main body such that the through-hole and the communication portion are continuous.

In short, the configurations of the cooler main bodies and the supply-discharge portions in the embodiments described above are exemplifications, and the configuration may be a configuration in which the supply-discharge portion can be arranged in a preset position in the cooler main body by bringing the contacting portion of the supply-discharge portion into substantial contact with the portion to be contacted of the electricity storage apparatus.

The present disclosure is not limited to the embodiments described above and can be changed, as appropriate, without departing from the gist.

What is claimed is:

1. A cooler to be mounted on an electricity storage apparatus, the cooler comprising:
a cooler main body in which a circulation passage of a refrigerant is provided; and
a supply-discharge portion that communicates with the circulation passage of the cooler main body and is configured to be inserted into the cooler main body to supply the refrigerant to the circulation passage of the cooler main body or discharge the refrigerant from the circulation passage of the cooler main body, wherein
the supply-discharge portion includes a contacting portion configured to arrange the supply-discharge portion in a preset position in the cooler main body by being in contact with a portion to be contacted of the electricity storage apparatus, in a state in which the cooler is mounted on the electricity storage apparatus.

2. The cooler according to claim 1, wherein the portion to be contacted of the electricity storage apparatus is a case of the electricity storage apparatus.

3. The cooler according to claim 1, wherein the supply-discharge portion includes:
an insertion portion configured to be inserted into the cooler main body; and
a first packing member configured to be fixed to an inner peripheral surface of the insertion portion.

4. The cooler according to claim 3, wherein the insertion portion and the first packing member are integrally formed by resin.

5. The cooler according to claim 3, wherein:
the cooler main body is an extruded material of aluminum; and
the insertion portion is configured to be inserted into an end portion of the cooler main body and includes an insertion portion main body having a cap shape.

6. The cooler according to claim 1, wherein the supply-discharge portion includes an engaging portion configured to be engaged with a portion to be engaged provided in the cooler main body.

7. The cooler according to claim 6, wherein the cooler main body includes a second packing member configured to come into contact with the supply-discharge portion.

8. An arrangement structure of a supply-discharge portion that is arranged on a cooler main body in a cooler to supply a refrigerant to the cooler main body or discharge the refrigerant from the cooler main body, the cooler mounted on an electricity storage apparatus, the arrangement structure comprising:
the supply-discharge portion being inserted into the cooler main body; and
the supply-discharge portion being arranged in a preset position in the cooler main body by being in contact with a portion to be contacted of the electricity storage apparatus, in a state in which the cooler is mounted on the electricity storage apparatus.

9. The electricity storage apparatus, comprising the cooler according to claim 1.

10. The electricity storage apparatus according to claim 9, wherein the cooler is configured to be arranged between battery modules.

11. The electricity storage apparatus according to claim 10, wherein:
an insertion portion includes:
an insertion portion main body configured to be inserted into the cooler main body; and
a first communication portion that is provided in the insertion portion main body and communicates with the circulation passage of the cooler main body;
the first communication portion and a second communication portion are configured to be joined by a fitting structure; and
the second communication portion is a communication portion of a supply-discharge portion in a predetermined cooler;
the battery module is between the cooler and the predetermined cooler; and
the cooler and the predetermined cooler are adjacent to each other.
